(19) United States
(12) Patent Application Publication
(10) Pub. No.: US 2026/0246652 A1
(43) Pub. Date: Aug. 20, 2026

(54) INFORMATION PROCESSING SYSTEM, MANAGEMENT DEVICE, CONTROL DEVICE, AND INFORMATION PROCESSING METHOD

(71) Applicant: Panasonic Intellectual Property Management Co., Ltd., Osaka (JP)

(72) Inventor: Masao AKIMOTO, Chiba (JP)

(21) Appl. No.: 19/473,309

(22) PCT Filed: Mar. 11, 2024
(86) PCT No.: PCT/JP2024/009412

§ 371 Date: Oct. 7, 2025

(30) Foreign Application Priority Data
Apr. 13, 2023 (JP) 2023-065891

(51) Int. Cl. H04L 9/32; G07C 9/00; G07C 9/27

(52) U.S. Cl. CPC H04L 9/3268; G07C 9/00571; G07C 9/00817; G07C 9/27; G07C 2209/02

(57) ABSTRACT

An information processing system includes: an information terminal; a management device; and a control device. The management device includes: an information processor that issues a server certificate to the information terminal, and generates a CRL that is a list of a serial number of a revoked server certificate; and a communicator that transmits the server certificate issued to the information terminal, and transmits the revocation list generated to the control device. The information processor performs a first process of recording, in a predetermined form, consecutive serial numbers in the CRL to reduce a data size of the CRL compared to when the consecutive serial numbers are recorded individually.

### TECHNICAL FIELD

The present invention relates to an information processing system, a management device, a control device, and an information processing method.

### BACKGROUND ART

In public key authentication, a technique of using a certificate revocation list (CRL) is known as a technique of revoking a public key certificate issued by a certificate authority (even if the public key certificate is within a validity period). Patent Literature (PTL) 1 discloses a technique related to a CRL.

### CITATION LIST

### Patent Literature

[PTL 1] Japanese Patent No. 6719086

### SUMMARY OF INVENTION

### Technical Problem

The present invention provides an information processing system, etc. capable of reducing a data size of a revocation list such as a CRL.

### Solution to Problem

An information processing system according to one aspect of the present invention is an information processing system that is used to lift a restriction imposed by a device which restricts entry or exit of a product or a person to or from a space. The information processing system includes: an information terminal; a management device; and a control device. In the information processing system, the management device includes: an information processor that issues a server certificate to the information terminal, and generates a revocation list that is a list of a serial number of a revoked server certificate; and a first communicator that transmits the server certificate issued to the information terminal, and transmits the revocation list generated to the control device. The control device includes: a storage in which a root certificate and the revocation list are stored; a second communicator that receives the server certificate from the information terminal; and a controller that lifts the restriction imposed by the device when determining that the server certificate received is valid based on the revocation list, and succeeding in verification of a signature included in the server certificate received, using a public key included in the root certificate. The information processor performs a first process of recording, in a predetermined form, consecutive serial numbers in the revocation list to reduce a data size of the revocation list compared to when the consecutive serial numbers are recorded individually.

A management device according to one aspect of the present invention is a management device that issues a server certificate to an information terminal, the server certificate being for lifting a restriction imposed by a device which restricts entry or exit of a product or a person to or from a space. The management device includes: an information processor that issues the server certificate to the information terminal, and generates a revocation list that is a list of a serial number of a revoked server certificate; and a communicator that transmits the server certificate issued to the information terminal, and transmits the revocation list generated to a control device. In the management device, the control device includes a storage in which a root certificate and the revocation list are stored, and when receiving the server certificate from the information terminal, lifts the restriction imposed by the device on condition of (a) determining that the server certificate received is valid based on the revocation list and (b) succeeding in verification of a signature included in the server certificate received, using a public key included in the root certificate, and the information processor performs a first process of recording, in a predetermined form, consecutive serial numbers in the revocation list to reduce a data size of the revocation list compared to when the consecutive serial numbers are recorded individually.

A control device according to one aspect of the present invention is a control device that lifts a restriction imposed by a device which restricts entry or exit of a product or a person to or from a space. The control device includes: a storage in which a root certificate and a revocation list that is a list of a serial number of a revoked server certificate are stored; a communicator that receives a server certificate from an information terminal; and a controller that lifts the restriction imposed by the device when determining that the server certificate received is valid based on the revocation list, and succeeding in verification of a signature included in the server certificate received, using a public key included in the root certificate. In the control device, when a size of a data field in which the serial number is recorded in the revocation list is larger than a predetermined size, the controller recognizes that consecutive serial numbers are recorded in a predetermined form in the data field.

An information processing method according to one aspect of the present invention is an information processing method performed by an information processing system that is used to lift a restriction imposed by a device which restricts entry or exit of a product or a person to or from a space, the information processing system including an information terminal, a management device, and a control device. The information processing method includes: issuing, by the management device, a server certificate to the information terminal, and transmitting, by the management device, the server certificate issued to the information terminal; generating, by the management device, a revocation list that is a list of a serial number of a revoked server certificate, and transmitting, by the management device, the revocation list generated to the control device; receiving, by the control device, the server certificate from the information terminal; lifting, by the control device, the restriction imposed by the device when the control device (i) determines that the server certificate received is valid based on the revocation list stored in a storage included by the control device and (ii) succeeds in verification of a signature included in the server certificate received, using a public key included in a root certificate stored in the storage; and recording in a predetermined form, by the management device, consecutive serial numbers in the revocation list to reduce a data size of the revocation list compared to when the consecutive serial numbers are recorded individually.

An information processing method according to one aspect of the present invention is an information processing method performed by a management device that issues a server certificate to an information terminal, the server certificate being for lifting a restriction imposed by a device which restricts entry or exit of a product or a person to or from a space. The information processing method includes: issuing the server certificate to the information terminal, and transmitting the server certificate issued to the information terminal; and generating a revocation list that is a list of a serial number of a revoked server certificate, and transmitting the revocation list generated to a control device. In the information processing method, the control device includes a storage in which a root certificate and the revocation list are stored, and when receiving the server certificate from the information terminal, lifts the restriction imposed by the device on condition of (a) determining that the server certificate received is valid based on the revocation list and (b) succeeding in verification of a signature included in the server certificate received, using a public key included in the root certificate, and the information processing method further includes: recording, in a predetermined form, consecutive serial numbers in the revocation list to reduce a data size of the revocation list compared to when the consecutive serial numbers are recorded individually.

An information processing method according to one aspect of the present invention is an information processing method performed by a control device that lifts a restriction imposed by a device which restricts entry or exit of a product or a person to or from a space, the control device including a storage in which a root certificate and a revocation list that is a list of a serial number of a revoked server certificate are stored. The information processing method includes: receiving a server certificate from an information terminal; lifting the restriction imposed by the device when the server certificate received is determined to be valid based on the revocation list, and a signature included in the server certificate received is successfully verified using a public key included in the root certificate; and when a size of a data field in which the serial number is recorded in the revocation list is larger than a predetermined size, recognizing that consecutive serial numbers are recorded in a predetermined form in the data field.

A program according to one aspect of the present invention is a program for causing a computer to execute the above-described information processing method.

### Advantageous Effects of Invention

An information processing system, etc. according to one aspect of the present invention are capable of reducing the data size of a revocation list.

### BRIEF DESCRIPTION OF INVENTION

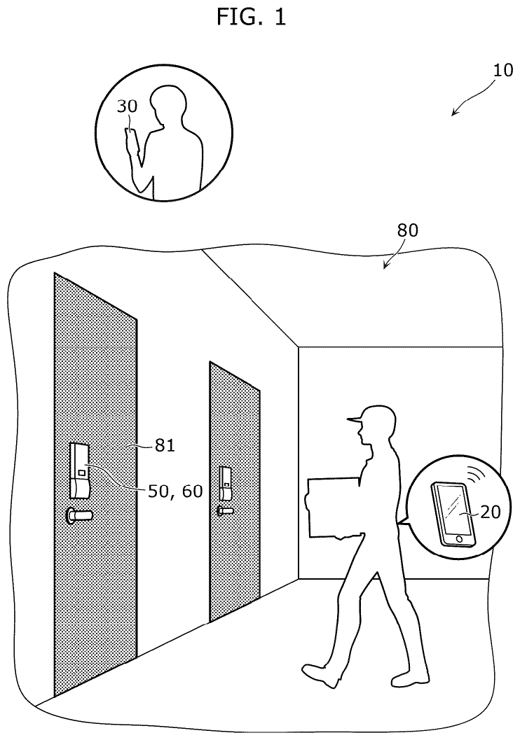

FIG. 1 is an external view of the information processing system according to an embodiment.

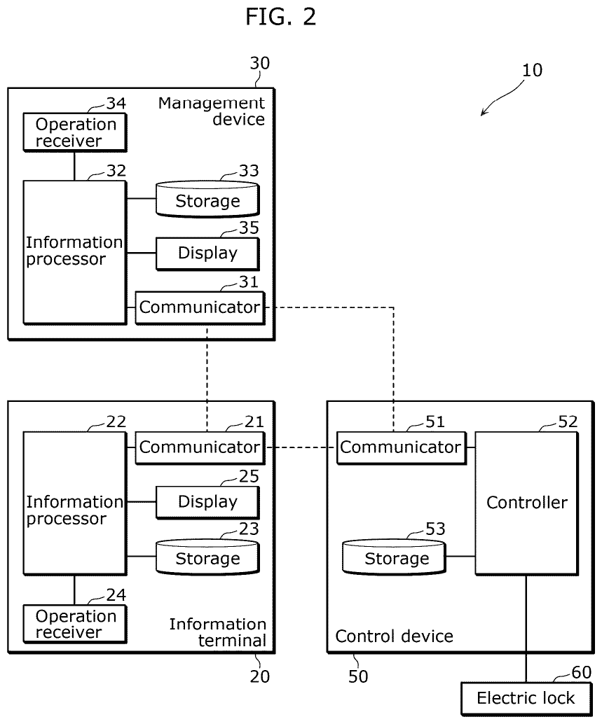

FIG. 2 is a block diagram illustrating a functional configuration of the information processing system according to the embodiment.

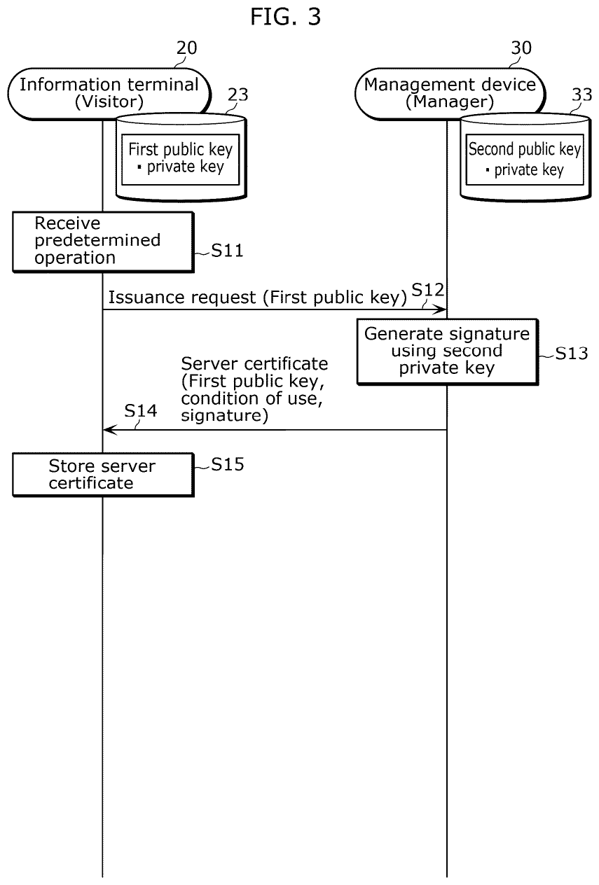

FIG. 3 is a sequence diagram of the first half of a fundamental operation of the information processing system according to the embodiment.

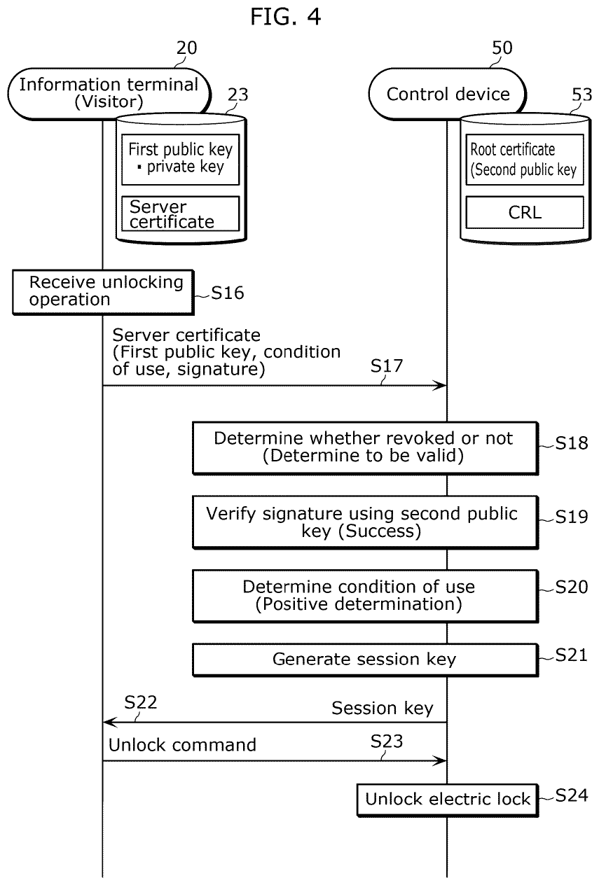

FIG. 4 is a sequence diagram of the second half of the fundamental operation of the information processing system according to the embodiment.

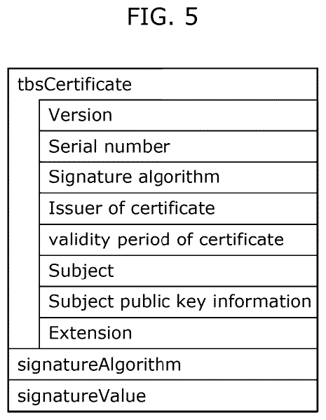

FIG. 5 is a diagram illustrating an example of a format of a server certificate.

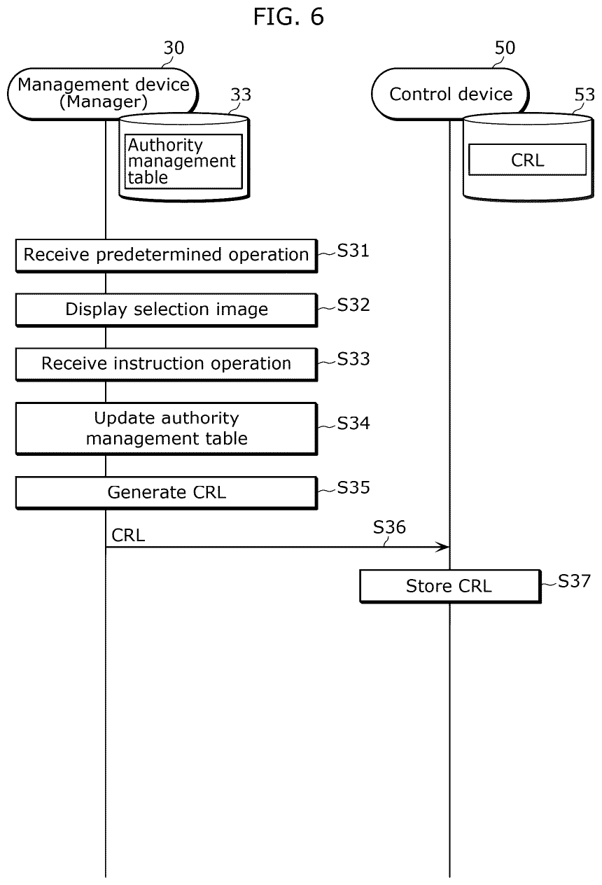

FIG. 6 is a sequence diagram of an operation of storing a CRL in a control device.

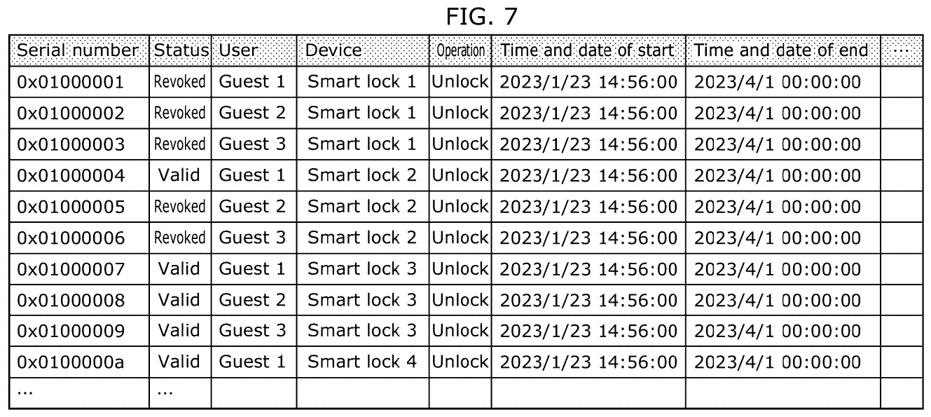

FIG. 7 is a diagram illustrating an example of an authority management table.

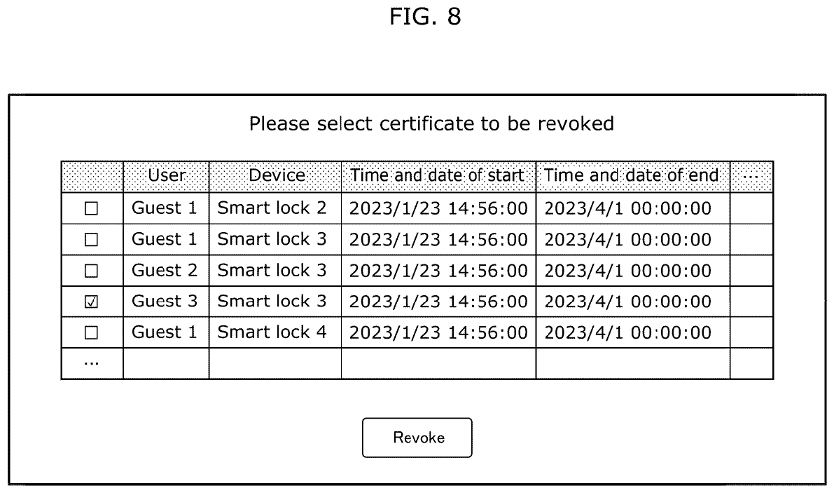

FIG. 8 is a diagram illustrating an example of a selection image for a server certificate.

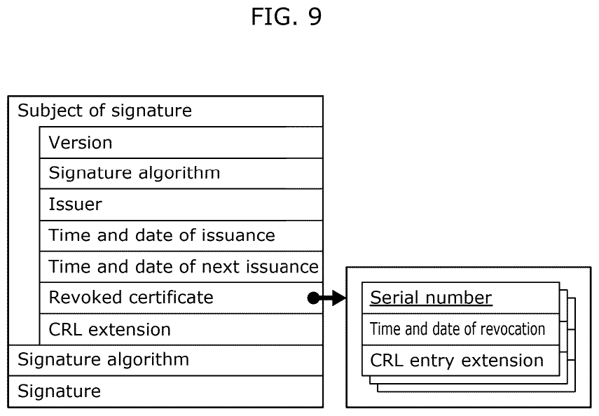

FIG. 9 is a diagram illustrating an example of a format of a CRL.

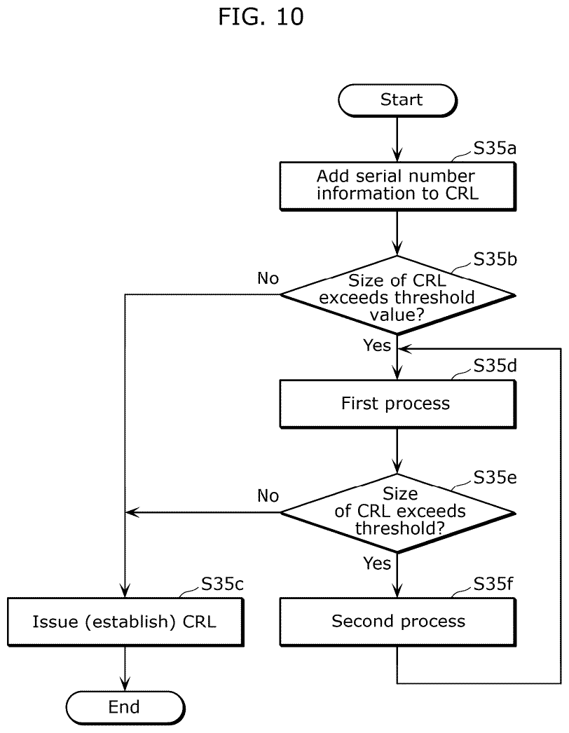

FIG. 10 is a flowchart of a generation operation of a CRL.

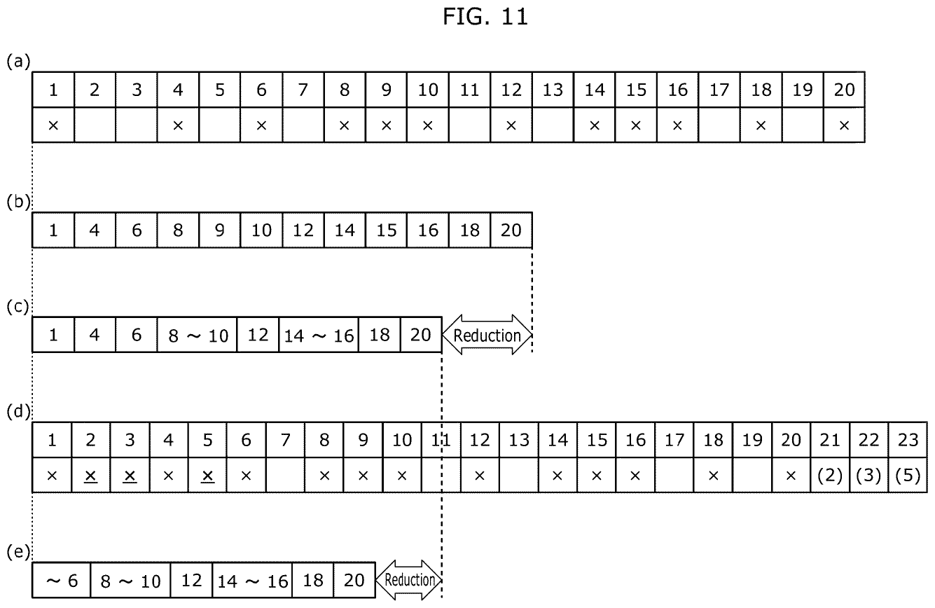

FIG. 11 is a schematic diagram to illustrate a specific example of the generation operation of a CRL.

### DESCRIPTION OF EMBODIMENTS

Hereinafter, an embodiment will be described in detail with reference to the Drawings. It should be noted that the embodiments described below each show a general or specific example. The numerical values, shapes, materials, structural components, the arrangement and connection of the structural components, steps, the processing order of the steps, and so on, shown in the following embodiment are mere examples, and therefore do not limit the present invention. Among the structural components in the embodiments described below, those not recited in the independent claims will be described as optional structural components.

In addition, each of the diagrams is a schematic diagram and not necessarily strictly illustrated. In each of the diagrams, substantially the same structural components are assigned with the same reference signs, and there are instances where redundant descriptions are omitted or simplified.

### Embodiment

### Configuration

First, the configuration of an information processing system according to an embodiment will be described. FIG. 1 s an external view of the information processing system according to the embodiment. FIG. 2 is a block diagram illustrating a functional configuration of the information processing system according to the embodiment.

As illustrated in FIG. 1, information processing system 10 according to the embodiment is a system for authorizing information terminal 20 to unlock (or lock) electric lock 60 in order for a visitor to facility 80 to unlock electric lock 60 using information terminal 20. Information processing system 10 includes: information terminal 20; management device 30; control device 50; and electric lock 60. Control device 50 and electric lock 60 are provided, for example, on door 81 (or a door frame) in facility 80 as an electric lock system. Facility 80 is, for example, a complex housing, but it may be a non-residential facility such as an office building.

Information terminal 20 is an information terminal that is used by a visitor to facility 80 to unlock electric lock 60. Information terminal 20 is a portable information terminal, such as a smartphone or a tablet terminal. Information terminal 20 includes communicator 21, information processor 22, storage 23, operation receiver 24, and display 25.

Communicator 21 is a communication circuit for information terminal 20 to communicate with each of management device 30 and control device 50. Communicator 21, for example, performs wireless communication with management device 30 through a wide area communication network such as the Internet, and performs wireless communication with control device 50 through a local communication network.

Information processor 22 performs information processing, etc. for unlocking electric lock 60. Information processor 22 is implemented by, for example, a microcomputer, but may also be implemented by a processor. The functions of information processor 22 are implemented by, for example, executing a computer program stored in storage 23, by a microcomputer, processor, or the like that constitutes information processor 22.

Storage 23 is a storage device in which information necessary for the above-described information processing and the above-described computer program, etc. are stored. Storage 23 is implemented, for example, by a semiconductor memory.

Operation receiver 24 receives an operation performed by a visitor. Operation receiver 24 is implemented by, for example, a touch panel, but may also be implemented by a hardware key, etc.

Display 25 displays an image. Display 25 is implemented by, for example, a display panel such as a liquid-crystal panel or an organic electroluminescent (EL) panel.

Management device 30 is an information terminal used by a manager or the like of facility 80. The manager or the like is, for example, an owner of facility 80 or an employee of a facility management agent for facility 80. Management device 30 is a portable information terminal, such as a smartphone or a tablet terminal. Management device 30 includes communicator 31, information processor 32, storage 33, operation receiver 34, and display 35.

Communicator 31 is a communication circuit for management device 30 to communicate with each of information terminal 20 and control device 50. Communicator 31 performs, for example, wireless communication with each of information terminal 20 and control device 50 through a wide area communication network.

Information processor 32 performs, for example, information processing for authorizing information terminal 20 to unlock electric lock 60. The information processing for authorizing information terminal 20 to unlock electric lock 60 is, for example, the processing of issuing a server certificate to information terminal 20 (described below). Information processor 32 is implemented by, for example, a microcomputer, but may also be implemented by a processor. The functions of information processor 32 are implemented by, for example, executing a computer program stored in storage 33, by a microcomputer, processor, or the like that constitutes information processor 32.

Storage 33 is a storage device in which information necessary for the above-described information processing and the above-described computer program, etc. are stored. Storage 33 is implemented, for example, by a semiconductor memory.

Operation receiver 34 receives an operation performed by a manager or the like. Operation receiver 34 is implemented by, for example, a touch panel, but may also be implemented by a hardware key, etc.

Display 35 displays an image. Display 35 is implemented by, for example, a display panel such as a liquid-crystal panel or an organic EL panel.

Control device 50 is a control device that controls the locking and unlocking of electric lock 60. Control device 50 is, for example, built into door 81 or a door frame. Control device 50 includes communicator 51, controller 52, and storage 53.

Communicator 51 is a communication circuit for control device 50 to communicate with each of information terminal 20 and management device 30. Communicator 51, for example, performs wireless communication with information terminal 20 through a local communication network, and performs wireless communication with management device 30 through a wide-area communication network.

Controller 52 performs information processing for locking or unlocking electric lock 60. More specifically, controller 52 locks or unlocks electric lock 60 by outputting a control signal to electric lock 60. Controller 52 is implemented by, for example, a microcomputer, but may also be implemented by a processor. The functions of controller 52 are implemented by, for example, executing a computer program stored in storage 53, by a microcomputer, processor, or the like that constitutes controller 52.

Storage 53 is a storage device in which information necessary for the above-described information processing and the above-described computer program, etc. are stored. Storage 53 is implemented, for example, by a semiconductor memory.

Electric lock 60 locks or unlocks door 81 based on a control signal output from controller 52. More specifically, electric lock 60 includes an electric motor and a transmission mechanism that transmits the driving force of the electric motor to the deadbolt. The driving force of the electric motor is transmitted to the deadbolt via the transmission mechanism, thereby causing the deadbolt to move to the locked or unlocked position.

### [Fundamental Operation]

Next, the fundamental operation of information processing system 10 will be described. FIG. 3 and FIG. 4 are sequence diagrams of the fundamental operation of information processing system 10. The following fundamental operation will be described as information terminal 20 being used by a visitor to facility 80, and management device 30 being used by the manager of facility 80. The visitor is, for example, a person dispatched by a housekeeping service provider, a package delivery person, or the like.

First, the operation until a server certificate is stored in storage 23 of information terminal 20 will be described with reference to FIG. 3. The server certificate serves as a permit to unlock electric lock 60. As illustrated in FIG. 3, a first public key and a first private key are stored in storage 23 of information terminal 20. The first public key and the first private key are generated, for example, when an application program (hereinafter also referred to simply as an application) for using information processing system 10 is installed on information terminal 20, and stored in storage 23.

In addition, a second public key and a second private key are stored in storage 33 of management device 30. The second public key and the second private key are stored, for example, in storage 33 when an application for using information processing system 10 is installed on management device 30.

First, the visitor performs a predetermined operation on operation receiver 24 of information terminal 20 which is running the above-described application. The predetermined operation is the operation to install a server certificate. Operation receiver 24 receives the predetermined operation (S11).

When the predetermined operation is received by operation receiver 24, information processor 22 generates an issuance request which is a request to issue a server certificate, and causes communicator 21 to transmit the generated issuance request to management device 30. The issuance request includes the first public key. In other words, communicator 21 transmits the first public key to management device 30 (S12). It should be noted that communicator 21 transmits the first public key to management device 30 via wireless communication through a wide area communication network. The issuance request corresponds to a certificate request defined by RFC 2986.

Communicator 31 of management device 30 receives the issuance request including the first public key. When the manager confirms the issuance request of the visitor and permits the visitor to unlock electric lock 60, information processor 32 generates a signature for the received first public key and a condition of use, using the second private key (S13). In addition, information processor 32 causes communicator 31 to transmit the server certificate including the first public key, the condition of use, and the signature to information terminal 20 (S14). The condition of use is, for example, information indicating a temporal condition (in other words, a validity period), which is predetermined by, for example, the manager, etc. using management device 30. Although it is not illustrated, the server certificate is stored in storage 33.

It should be noted that the X.509 certificate defined by RFC 5280, for example, is used as the format of the server certificate. FIG. 5 is a diagram illustrating an example of the format of a server certificate. The validity period of the certificate in FIG. 5 corresponds to the above-described condition of use, subject public key information corresponds to the first public key, and signatureValue corresponds to the signature. It should be noted that a condition of use other than the validity period may be stored in the extension area of the format in FIG. 5.

Communicator 21 of information terminal 20 receives the server certificate. Information processor 22 stores the received server certificate in storage 23 (S15).

Next, the operation until electric lock 60 is unlocked using a server certificate will be described with reference to FIG. 4. As illustrated in FIG. 4, a root certificate is stored in storage 53 of control device 50. The root certificate includes the second public key. The root certificate is, for example, generated by information processor 32 of management device 30 and transmitted to control device 50 by communicator 31, thereby being stored in storage 53. The root certificate may be stored in storage 53 by the manufacturing facility at the time of manufacture of control device 50. It should be noted that the root certificate is also stored in storage 33 of management device 30.

A certificate revocation list (CRL) is stored in storage 53 of control device 50. A CRL is an example of a revocation list, and is a list of serial numbers of revoked server certificates.

First, a visitor approaches door 81 and performs, on operation receiver 24 of information terminal 20 which is running the above-described application, a predetermined unlocking operation to unlock electric lock 60. Operation receiver 24 receives the unlocking operation (S16). It should be noted that door 81 is, for example, a door provided in a private area of facility 80 (see FIG. 1), but door 81 may also be a door provided at the entrance of facility 80 or a door provided in a common area other than the entrance.

When the unlocking operation is received by operation receiver 24, information processor 22 causes communicator 21 to transmit a server certificate to control device 50. In other words, communicator 21 transmits the server certificate to control device 50 (S17). Communicator 21 transmits the server certificate to control device 50 via wireless communication through the local communication network. This wireless communication is, for example, short-distance wireless communication based on communication standards such as Bluetooth (registered trademark).

Communicator 51 of control device 50 receives the server certificate. Controller 52 determines whether the received server certificate has been revoked (listed or not listed in the CRL) by referring to the CRL stored in storage 53 (S18). When it is determined that the received server certificate has been revoked (listed in the CRL), no further processing subsequent to step S18 is performed.

When controller 52 determines that the received server certificate is valid (not listed in the CRL), controller 52 verifies the signature included in the received server certificate, using the second public key included in the root certificate stored in storage 53 (S19). When the signature is successfully verified, controller 52 determines the condition of use included in the server certificate (S20). As described above, the condition of use is, for example, a temporal condition, and controller 52 determines whether the temporal condition is satisfied. When controller 52 determines that the temporal condition is satisfied, controller 52 generates a session key using the first public key included in the server certificate (S21). Controller 52 encrypts the generated session key with the first public key, and causes communicator 51 to transmit the encrypted session key to information terminal 20 (S22).

Communicator 21 of information terminal 20 receives the encrypted session key. Information processor 22 decrypts the session key using the first private key, and causes communicator 21 to transmit an unlock command to control device 50 by encrypted communication using the session key (S23).

Communicator 51 of control device 50 receives the unlock command. Controller 52 unlocks electric lock 60 based on the received unlock command (S24). More specifically, controller 52 unlocks electric lock 60 by transmitting a control signal to electric lock 60. It should be noted that information terminal 20 is also capable of locking electric lock 60 based on a similar sequence of operation.

As described above, in information processing system 10, management device 30 is capable of securely authorizing information terminal 20 to unlock electric lock 60, using the server certificate and the root certificate.

It should be noted that the object of control of control device 50 is not limited to electric lock 60. Control device 50 may control any device that restricts entry into or exit from a space in facility 80. For example, control device 50 may control the opening and closing of an automatic door provided at the entrance of facility 80.

### [Operation of Storing CRL]

The above-described CRL is generated by management device 30 and transmitted from management device 30 to control device 50, and then stored in storage 53 of control device 50. Hereinafter, the operation of storing a CRL in storage 53 will be described. FIG. 6 is a sequence diagram of the operation of storing CRL in control device 50.

As illustrated in FIG. 6, an authority management table is stored in storage 33 of management device 30. FIG. 7 is a diagram illustrating an example of the authority management table. As illustrated in FIG. 7, in the authority management table, the serial number of a server certificate, the current status (valid or revoked) of the server certificate, the identification information of the visitor (user) who has provided the server certificate, the identification information of electric lock 60 (in FIG. 7, described as smart lock) that can be unlocked by the server certificate, and a temporal condition (validity period) are associated with one another. It can be said that the authority management table is information indicating which server certificates have been issued to which visitors.

First, a manager performs a predetermined operation on operation receiver 34 of management device 30. Operation receiver 34 receives the predetermined operation (S31).

When the predetermined operation is received by operation receiver 34, information processor 32 displays, on display 35, a selection image for selecting a server certificate to be revoked (to be listed in the CRL), based on the authority management table stored in storage 33 (S32). FIG. 8 is a diagram illustrating an example of the selection image for a server certificate. In the selection image illustrated in FIG. 8, server certificates which have already been revoked by the CRL are not displayed. In addition, to revoke a server certificate by a CRL means to revoke a server certificate even when the server certificate is within the validity period, and thus server certificates which have expired are not displayed in the selection image in FIG. 8.

When the selection image of FIG. 8 is displayed, the manager selects a server certificate to be revoked, and performs an instruction operation to instruct revocation of the server certificate that has been selected. Operation receiver 34 receives the instruction operation (S33).

When the predetermined operation is received by operation receiver 34, information processor 32 updates the authority management table (S34), and generates a CRL including a list of the serial numbers of the server certificates that have been revoked even though they are within the validity period (S35). In addition, information processor 32 causes communicator 31 to transmit the generated CRL to control device 50 (S36).

Communicator 51 of control device 50 receives the CRL. Controller 52 stores the received CRL in storage 53 (S37). In other words, controller 52 updates the CRL stored in storage 53.

As described above, the manager can revoke a server certificate that is within a validity period, by performing the predetermined operation on management device 30.

[Extension of serial number field of CRL]

The format of a CRL is defined as FIG. 9, in section 5.1 of RFC 5280. FIG. 9 is a diagram illustrating the format of a CRL. As illustrated in FIG. 9, in the CRL, serial number information including the serial number of a revoked server certificate, the time and date of revocation, and the CRL entry extension is stored in the field of “Revoked certificate” of the format, as many times as the total number of revoked server certificates.

In other words, the data size of the CRL increases according to the total number of revoked server certificates. In an embedded device such as control device 50, it is difficult to ensure sufficient storage capacity in storage 53, and thus there is a risk that the CRL cannot be stored in storage 53 when the data size of the CRL increases. In other words, there is a risk that control device 50 will not be able to identify the revoked server certificate.

In view of the above, although generally only one serial number can be recorded in one serial number information, two or more consecutive serial numbers are recorded in one serial number information in information processing system 10, thereby reducing the data size of the CRL.

For example, when the data length of the serial number is a fixed length of six bytes, the size of the serial number field (the field indicated as “serial number” in FIG. 9, i.e., the data field in which the serial number is recorded) is extended to 12 bytes, with the first six bytes as a first serial number and the second six bytes as a second serial number.

The serial number information in the first form with the serial number field extended to 12 bytes as described above means that two or more serial numbers that correspond to a first serial number or larger and a second serial number or smaller have been revoked. In other words, two or more serial numbers are recorded in one serial number information. Only one time and date of revocation and one CRL entry extension are recorded for two or more serial numbers.

It should be noted that one serial number is recorded as usual in the serial number information with the size of the serial number field being six bytes. Controller 52 of control device 50 is capable of recognizing that, in a CRL, two or more consecutive serial numbers are recorded in the serial number field when the size of the serial number field is 12 bytes (i.e., larger than the usual six bytes (one example of a predetermined size)).

Serial number information in the second form may be prepared. The serial number information in the second form means that all serial numbers smaller than or equal to a reference serial number or all serial numbers larger than or equal to the reference serial number have been revoked. In this case, the size of the serial number field is extended to seven bytes with the first one byte being a specified range (larger than or equal to or smaller than or equal to) and the following six bytes being the reference serial number. In this case, the reference serial number is the first serial number or the last serial number among the consecutive serial numbers.

As described above, management device 30 records consecutive serial numbers in a predetermined form (i.e., serial numbers are recorded by extending the serial number field) in a CRL. The predetermined form includes the first form in which only the first and last serial numbers among consecutive serial numbers are recorded, and the second form in which the first or last serial number among consecutive serial numbers and a specified range based on the first or last serial number are recorded.

In this manner, it is possible to reduce the data size of the CRL compared to when all consecutive serial numbers are recorded individually, because the information associated with consecutive serial numbers is organized into one. The larger the total number of consecutive serial numbers, the greater the reduction effect in a CRL data size.

### [Generation Operation of CRL]

The following describes the generation operation of a CRL when a serial number field is extended to record serial numbers. FIG. 10 is a flowchart of the generation operation of a CRL. The operation illustrated by the flowchart in FIG. 10 corresponds to the operation in step S35 of FIG. 6.

First, information processor 32 of management device 30 generates serial number information of the server certificate selected by the user for revocation, one per server certificate (serial number) as usual, and adds the serial number information to a CRL (S35a). Next, information processor 32 determines whether the data size of the CRL after the serial number information has been added exceeds a threshold (S35b).

When information processor 32 determines that the data size of the CRL does not exceed the threshold (No in S35b), information processor 32 issues (establishes) the CRL (S35c). When information processor 32 determines that the data size of the CRL exceeds the threshold (Yes in S35b), information processor 32 performs a first process of consolidating serial number information of consecutive serial numbers into one (S35d). In the first process, two or more items of serial number information are consolidated into one item of serial number information with a size of the serial number field being extended. The first process, in other words, is a process to record the serial number by extending the serial number field (to 12 bytes or seven bytes).

Next, information processor 32 determines whether the data size of the CRL after the first process exceeds the threshold (S35e). When information processor 32 determines that the data size of the CRL does not exceed the threshold (No in S35e), information processor 32 issues (establishes) the CRL (S35c). When information processor 32 determines that the data size of the CRL exceeds the threshold (Yes in S35e), information processor 32 performs a second process of increasing a total number of consecutive serial numbers in the CRL (S35f). More specifically, information processor 32 revokes the valid server certificate and issues a new server certificate in place of the valid server certificate (steps S13 to S15 of FIG. 3), thereby increasing the total number of consecutive serial numbers. Information processor 32 then performs the first process again (S35d).

The generation operation of a CRL described above will be explained in more detail with reference to FIG. 11. FIG. 11 is a schematic diagram to illustrate a specific example of the generation operation of a CRL.

In FIG. 11, (a) means that server certificates with serial numbers 1 through 20 have been issued, and server certificates marked with X have been revoked.

In this case, when the process pf step S35a is performed, one item of serial number information is generated per server certificate (serial number), as illustrated in (b) of FIG. 11.

Furthermore, when the first process in step S35d is performed, the items of serial number information of consecutive serial numbers are consolidated into one, as illustrated in (c) of FIG. 11. In (c) of FIG. 11, three items of serial number information corresponding to serial numbers 8, 9, and 10 are consolidated into one item of serial number information, and three items of serial number information corresponding to serial numbers 14, 15, and 16 are consolidated into one item serial number information. In this manner, the data size of the CRL is reduced compared to (b) in FIG. 11.

In the consolidation in (c) of FIG. 11, the serial number information in the first form is used. In other words, the process of extending the serial number field to 12 bytes to record the serial number is performed.

Furthermore, when the second process in step S35f is performed, the three items of serial number information corresponding to serial numbers 2, 3, and 5 are revoked, and serial numbers 21, 22, and 23 are issued as replacement server certificates, as illustrated n in (d) of FIG. 11.

When the first process in step S35d is performed again, the items of serial number information of consecutive serial numbers are consolidated into one, as illustrated in (e) of FIG. 11. In (c) of FIG. 11, six items of serial number information corresponding to serial numbers 1, 2, 3, 4, 5, and 6 are consolidated into one item of serial number information. In this manner, the data size of the CRL is reduced compared to (c) in FIG. 11.

In the consolidation in (e) of FIG. 11, the serial number information in the second form is used. In other words, the process of extending the serial number field to seven bytes to record the serial number is performed.

As described above, management device 30 performs the first process when the data size of the CRL exceeds the threshold. When the data size of the CRL still exceeds the threshold even after the first process has been performed, management device 30 performs the second process and then performs once again the first process. In this manner, management device 30 is capable of keeping the data size of the CRL less than or equal to the threshold.

### [Variation]

In the foregoing embodiment, control device 50 controls the device that restricts the entry or exit of a person to or from a space in facility 80, such as electric lock 60 or an automatic door. However, control device 50 may control a device that restricts the entry or exit of a product. For example, control device 50 may control an electric lock that locks and unlocks the door of a delivery box, a coin-operated locker, a safe-deposit box, or the like. In other words, it is sufficient if control device 50 controls a device that restricts the entry or exit of a product or a person to or from the space.

In addition, information processing system 10 can be applied not only to devices that restrict the entry or exit of a product or a person to or from a space, but also to the case where only a certain person is permitted to control home appliances, such as a lighting device and an air conditioning equipment.

### [Advantageous Effects, Etc.]

Hereinafter, the inventions that can be achieved from the disclosure of this Description will be exemplified, and advantageous effects, etc., yielded from the inventions exemplified will be described.

Invention 1 is information processing system 10 that is used to lift a restriction imposed by a device which restricts entry or exit of a product or a person to or from a space. Information processing system 10 includes: information terminal 20; management device 30; and control device 50. In information processing system 10, management device 30 includes: information processor 32 that issues a server certificate to information terminal 20, and generates a CRL that is a list of a serial number of a revoked server certificate; and communicator 31 that transmits the server certificate issued to information terminal 20, and transmits the CRL generated to control device 50. Control device 50 includes: storage 53 in which a root certificate and the CRL are stored; communicator 51 that receives the server certificate from information terminal 20; and controller 52 that lifts the restriction imposed by the device when determining that the server certificate received is valid based on the CRL, and succeeding in verification of a signature included in the server certificate received, using a public key included in the root certificate. Information processor 32 performs a first process of recording, in a predetermined form, consecutive serial numbers in the CRL to reduce a data size of the CRL compared to when the consecutive serial numbers are recorded individually. The CRL is an example of a revocation list, communicator 31 is an example of a first communicator, and communicator 51 is an example of a second communicator. The device is, for example, electric lock 60, or the like.

Such information processing system 10 is capable of reducing the data size of a CRL. In an embedded device such as control device 50, it is difficult to ensure sufficient storage capacity in storage 53, and thus the benefit of being able to reduce the data size of a CRL is significant.

Invention 2 is information processing system 10 according to Invention 1, and in information processing system 10, information processor 32 further performs a second process of revoking a valid server certificate and issuing a new server certificate in place of the valid server certificate to increase a total number of consecutive serial numbers in the CRL.

Such information processing system 10 is capable of further reducing the data size of a CRL.

Invention 3 is information processing system 10 according to Invention 1 or 2, and in information processing system 10, information processor 32 performs the first process when the data size of the CRL exceeds a threshold.

Such information processing system 10 is capable of reducing the data size of a CRL to be less than or equal to the threshold by the first process.

Invention 4 is information processing system 10 according to Invention 2, and in information processing system 10, when the data size of the CRL exceeds a threshold, information processor 32 performs the first process, and when the data size of the CRL still exceeds the threshold after performing the first process, performs the first process again after performing the second process.

Such information processing system 10 is capable of reducing the data size of a CRL to be less than or equal to the threshold by performing both the first process and the second process.

Invention 5 is information processing system 10 according to any one of Inventions 1 to 4, and in information processing system 10, the predetermined form includes a first form in which only a first serial number and a last serial number among the consecutive serial numbers are recorded.

With such information processing system 10, as to consecutive serial numbers, by recording only the first and last serial numbers among the consecutive serial numbers, it is possible to reduce the data size of a CRL compared to when the consecutive serial numbers are recorded individually.

Invention 6 is information processing system 10 according to any one of Inventions 1 to 5, and in information processing system 10, the predetermined form includes a second form in which a first serial number or a last serial number among the consecutive serial numbers and a specified range based on the first serial number or the last serial number are recorded.

With such information processing system 10, by recording the first or last serial number among the consecutive serial numbers and a specified range based on the first or last serial number, it is possible to reduce the data size of a CRL compared to when the consecutive serial numbers are recorded individually.

Invention 7 is management device 30 that issues a server certificate to information terminal 20, the server certificate being for lifting a restriction imposed by a device which restricts entry or exit of a product or a person to or from a space. Management device 30 includes: information processor 32 that issues the server certificate to information terminal 20, and generates a CRL that is a list of a serial number of a revoked server certificate; and communicator 31 that transmits the server certificate issued to information terminal 20, and transmits the CRL generated to control device 50. In management device 30, control device 50 includes storage 53 in which a root certificate and the CRL are stored, and when receiving the server certificate from information terminal 20, lifts the restriction imposed by the device on condition of (a) determining that the server certificate received is valid based on the CRL and (b) succeeding in verification of a signature included in the server certificate received, using a public key included in the root certificate, and information processor 32 performs a first process of recording, in a predetermined form, consecutive serial numbers in the CRL to reduce a data size of the CRL compared to when the consecutive serial numbers are recorded individually.

Such management device 30 is capable of reducing the data size of a CRL.

Invention 8 is control device 50 that lifts a restriction imposed by a device which restricts entry or exit of a product or a person to or from a space. Control device 50 includes: storage 53 in which a root certificate and a CRL that is a list of a serial number of a revoked server certificate are stored; communicator 51 that receives a server certificate from information terminal 20; and controller 52 that lifts the restriction imposed by the device when determining that the server certificate received is valid based on the CRL, and succeeding in verification of a signature included in the server certificate received, using a public key included in the root certificate. In control device 50, when a size of a data field in which the serial number is recorded in the CRL is larger than a predetermined size, controller 52 recognizes that consecutive serial numbers are recorded in a predetermined form in the data field.

Such control device 50 is capable of correctly recognizing the serial number of a revoked server certificate.

Invention 9 is an information processing method performed by information processing system 10 that is used to lift a restriction imposed by a device which restricts entry or exit of a product or a person to or from a space. Information processing system 10 includes information terminal 20, management device 30, and control device 50. The information processing method includes: step S14 of issuing, by management device 30, a server certificate to information terminal 20, and transmitting, by management device 30, the server certificate issued to information terminal 20; steps S35 and S36 of generating, by management device 30, a CRL that is a list of a serial number of a revoked server certificate, and transmitting, by management device 30, the CRL generated to control device 50; step S17 of receiving, by control device 50, the server certificate from information terminal 20; step S24 of lifting, by control device 50, the restriction imposed by the device when control device 50 (i) determines that the server certificate received is valid based on the CRL stored in storage 53 included by control device 50 and (ii) succeeds in verification of a signature included in the server certificate received, using a public key included in a root certificate stored in storage 53; and step S35d recording in a predetermined form, by management device 30, consecutive serial numbers in the CRL to reduce a data size of the CRL compared to when the consecutive serial numbers are recorded individually.

Such an information processing method is capable of reducing the data size of a CRL.

Invention 10 is an information processing method performed by management device 30 that issues a server certificate to information terminal 20, the server certificate being for lifting a restriction imposed by a device which restricts entry or exit of a product or a person to or from a space. The information processing method includes: step S14 of issuing the server certificate to information terminal 20, and transmitting the server certificate issued to information terminal 20; and steps S35 and D36 of generating a CRL that is a list of a serial number of a revoked server certificate, and transmitting the CRL generated to control device 50. In the information processing method, control device 50 includes storage 53 in which a root certificate and the CRL are stored, and when receiving the server certificate from information terminal 20, lifts the restriction imposed by the device on condition of (a) determining that the server certificate received is valid based on the CRL and (b) succeeding in verification of a signature included in the server certificate received, using a public key included in the root certificate, and the information processing method further includes: step S35d of recording, in a predetermined form, consecutive serial numbers in the CRL to reduce a data size of the CRL compared to when the consecutive serial numbers are recorded individually.

Such an information processing method is capable of reducing the data size of a CRL.

Invention 11 is an information processing method performed by control device 50 that lifts a restriction imposed by a device which restricts entry or exit of a product or a person to or from a space. Control device 50 includes storage 53 in which a root certificate and a CRL that is a list of a serial number of a revoked server certificate are stored. The information processing method includes: step S17 of receiving a server certificate from information terminal 20; step S24 of lifting the restriction imposed by the device when the server certificate received is determined to be valid based on the CRL, and a signature included in the server certificate received is successfully verified using a public key included in the root certificate; and step S18 of, when a size of a data field in which the serial number is recorded in the CRL is larger than a predetermined size, recognizing that consecutive serial numbers are recorded in a predetermined form in the data field.

Such an information processing method is capable of correctly recognizing the serial number of a revoked server certificate.

Invention 12 is a program for causing a computer to execute the information processing method according to any one of Inventions 9 to 11.

With such a program, information processing system 10 and management device 30 are capable of reducing the data size of a CRL, and control device 50 is capable of correctly recognizing the serial number of a revoked server certificate.

### Other Embodiments

Although the embodiments have been described thus far, the present invention is not limited to the above-described embodiments.

For example, in the above-described embodiments, the information processing system has been implemented by a plurality of devices, but the information processing system may be implemented as a single device. For example, the information processing system may be implemented as a single device corresponding to any of the information terminal, the management device, and the control device. When the information processing system is implemented by a plurality of devices, the structural components (in particular, the functional structural components) included in the information processing system may be distributed in any manner to the plurality of devices.

In addition, in the above-described embodiments, a process performed by a specific processing unit may be performed by a different processing unit. Furthermore, the order of a plurality of processes may be rearranged. Alternatively, the plurality of processes may be performed in parallel.

In addition, each of the structural components in the above-described embodiments may be implemented by executing a software program suitable for the structural component. Each of the structural components may be implemented by means of a program executing unit, such as a CPU or a processor, reading and executing the software program recorded on a recording medium such as a hard disk or a semiconductor memory.

In addition, each of the structural components may be implemented by hardware. For example, each of the structural components may be a circuitry (or an integrated circuit). The circuitries may be configured as a single circuitry as a whole or may be mutually different circuitries. In addition, the circuitries may each be a general-purpose circuit, or may be a dedicated circuit.

In addition, the generic or specific aspects of the present invention may be implemented by a system, a device, a method, an integrated circuit, a computer program, or a computer-readable recording medium such as a compact disc read only memory (CD-ROM). Alternatively, the generic or specific aspects of the present invention may be implemented by any combination of systems, devices, methods, integrated circuits, computer programs, and recording medium.

For example, the present invention may be implemented as the information terminal, the management device, the control device, or the electric lock system (control device and electric lock) according to the above-described embodiments.

Alternatively, the present invention may be implemented as an information processing method executed by a computer such as the information processing system according to the above-described embodiments. In addition, the present invention may be implemented as a program for causing a computer to execute the information processing method. The present invention may be implemented as a non-transitory computer-readable recording medium on which the above-described program is stored.

In addition, the present invention may be implemented as an application program for causing a general-purpose information terminal to function as the information terminal or the management device according to the foregoing embodiments. The present invention may be implemented as a non-transitory computer-readable recording medium on which the above-described application program is stored.

It should be noted that the present invention also includes other forms in which various modifications apparent to those skilled in the art are applied to the embodiments or forms in which structural components and functions in the embodiments are arbitrarily combined within the scope of the present invention.

### REFERENCE SIGNS LIST

10 information processing system
20 information terminal
21 communicator
22, 32 information processor
23, 33, 53 storage
24, 34 operation receiver
25, 35 display
30 management device
31 communicator (first communicator)
50 control device
51 communicator (second communicator)
52 controller
60 electric lock (device)
80 facility
81 door

1. An information processing system that is used to lift a restriction imposed by a device which restricts entry or exit of a product or a person to or from a space, the information processing system comprising:
an information terminal; a management device; and a control device, wherein
the management device includes:
an information processor that issues a server certificate to the information terminal, and generates a revocation list that is a list of a serial number of a revoked server certificate; and
a first communicator that transmits the server certificate issued to the information terminal, and transmits the revocation list generated to the control device,
the control device includes:
a storage in which a root certificate and the revocation list are stored;
a second communicator that receives the server certificate from the information terminal; and
a controller that lifts the restriction imposed by the device when determining that the server certificate received is valid based on the revocation list, and succeeding in verification of a signature included in the server certificate received, using a public key included in the root certificate, and
the information processor performs a first process of recording, in a predetermined form, consecutive serial numbers in the revocation list to reduce a data size of the revocation list compared to when the consecutive serial numbers are recorded individually.

2. The information processing system according to claim 1, wherein the information processor further performs a second process of revoking a valid server certificate and issuing a new server certificate in place of the valid server certificate to increase a total number of consecutive serial numbers in the revocation list.

3. The information processing system according to claim 1, wherein the information processor performs the first process when the data size of the revocation list exceeds a threshold.

4. The information processing system according to claim 2, wherein when the data size of the revocation list exceeds a threshold, the information processor performs the first process, and when the data size of the revocation list still exceeds the threshold after performing the first process, performs the first process again after performing the second process.

5. The information processing system according to claim 1, wherein
the predetermined form includes a first form in which only a first serial number and a last serial number among the consecutive serial numbers are recorded.

6. The information processing system according to claim 1, wherein
the predetermined form includes a second form in which a first serial number or a last serial number among the consecutive serial numbers and a specified range based on the first serial number or the last serial number are recorded.

7. A management device that issues a server certificate to an information terminal, the server certificate being for lifting a restriction imposed by a device which restricts entry or exit of a product or a person to or from a space, the management device comprising:
an information processor that issues the server certificate to the information terminal, and generates a revocation list that is a list of a serial number of a revoked server certificate; and
a communicator that transmits the server certificate issued to the information terminal, and transmits the revocation list generated to a control device, wherein
the control device includes a storage in which a root certificate and the revocation list are stored, and when receiving the server certificate from the information terminal, lifts the restriction imposed by the device on condition of (a) determining that the server certificate received is valid based on the revocation list and (b) succeeding in verification of a signature included in the server certificate received, using a public key included in the root certificate, and
the information processor performs a first process of recording, in a predetermined form, consecutive serial numbers in the revocation list to reduce a data size of the revocation list compared to when the consecutive serial numbers are recorded individually.

8. A control device that lifts a restriction imposed by a device which restricts entry or exit of a product or a person to or from a space, the control device comprising:
a storage in which a root certificate and a revocation list that is a list of a serial number of a revoked server certificate are stored;
a communicator that receives a server certificate from an information terminal; and
a controller that lifts the restriction imposed by the device when determining that the server certificate received is valid based on the revocation list, and succeeding in verification of a signature included in the server certificate received, using a public key included in the root certificate, wherein
when a size of a data field in which the serial number is recorded in the revocation list is larger than a predetermined size, the controller recognizes that consecutive serial numbers are recorded in a predetermined form in the data field.

9. An information processing method performed by an information processing system that is used to lift a restriction imposed by a device which restricts entry or exit of a product or a person to or from a space,
the information processing system including an information terminal, a management device, and a control device,
the information processing method comprising:
issuing, by the management device, a server certificate to the information terminal, and transmitting, by the management device, the server certificate issued to the information terminal;
generating, by the management device, a revocation list that is a list of a serial number of a revoked server certificate, and transmitting, by the management device, the revocation list generated to the control device;
receiving, by the control device, the server certificate from the information terminal;
lifting, by the control device, the restriction imposed by the device when the control device (i) determines that the server certificate received is valid based on the revocation list stored in a storage included by the control device and (ii) succeeds in verification of a signature included in the server certificate received, using a public key included in a root certificate stored in the storage; and
recording in a predetermined form, by the management device, consecutive serial numbers in the revocation list to reduce a data size of the revocation list compared to when the consecutive serial numbers are recorded individually.

10. An information processing method performed by a management device that issues a server certificate to an information terminal, the server certificate being for lifting a restriction imposed by a device which restricts entry or exit of a product or a person to or from a space, the information processing method comprising:
issuing the server certificate to the information terminal, and transmitting the server certificate issued to the information terminal; and
generating a revocation list that is a list of a serial number of a revoked server certificate, and transmitting the revocation list generated to a control device, wherein
the control device includes a storage in which a root certificate and the revocation list are stored, and when receiving the server certificate from the information terminal, lifts the restriction imposed by the device on condition of (a) determining that the server certificate received is valid based on the revocation list and (b) succeeding in verification of a signature included in the server certificate received, using a public key included in the root certificate, and
the information processing method further comprises: recording, in a predetermined form, consecutive serial numbers in the revocation list to reduce a data size of the revocation list compared to when the consecutive serial numbers are recorded individually.

11. An information processing method performed by a control device that lifts a restriction imposed by a device which restricts entry or exit of a product or a person to or from a space,
the control device including a storage in which a root certificate and a revocation list that is a list of a serial number of a revoked server certificate are stored,
the information processing method comprising:
receiving a server certificate from an information terminal;
lifting the restriction imposed by the device when the server certificate received is determined to be valid based on the revocation list, and a signature included in the server certificate received is successfully verified using a public key included in the root certificate; and
when a size of a data field in which the serial number is recorded in the revocation list is larger than a predetermined size, recognizing that consecutive serial numbers are recorded in a predetermined form in the data field.

12. A non-transitory computer-readable recording medium having recorded thereon a computer program for causing a computer to execute the information processing method according to claim 9.

13. A non-transitory computer-readable recording medium having recorded thereon a computer program for causing a computer to execute the information processing method according to claim 10.

14. A non-transitory computer-readable recording medium having recorded thereon a computer program for causing a computer to execute the information processing method according to claim 11.
